(19) United States
(12) Patent Application Publication
(10) Pub. No.: US 2025/0211069 A1
(43) Pub. Date: Jun. 26, 2025

(54) CONTROL DEVICE

(71) Applicant: TOYOTA JIDOSHA KABUSHIKI KAISHA, Toyota-shi (JP)

(72) Inventor: Naoya ODASHIMA, Toyota-shi (JP)

(73) Assignee: TOYOTA JIDOSHA KABUSHIKI KAISHA, Toyota-shi (JP)

(21) Appl. No.: 18/955,016

(22) Filed: Nov. 21, 2024

(30) Foreign Application Priority Data
Dec. 26, 2023 (JP) 2023-219967

(51) Int. Cl. H02K 11/25; H02K 9/19

(52) U.S. Cl. CPC H02K 11/25; H02K 9/19

(57) ABSTRACT

A control device is used in a motor device including a motor, an inverter that drives the motor, a cooling device that cools the inverter with a cooling medium, and a current sensor mounted on a connection line connecting the motor and the inverter, and the control device is configured to control the inverter. The control device includes an electronic control unit configured to derive an estimated temperature that is an estimated value of a temperature of the current sensor, based on a coil temperature and a cooling medium temperature, and to limit power output from the motor based on the estimated temperature, the coil temperature being a temperature of a coil of the motor, and the cooling medium temperature being a temperature of the cooling medium.

### CROSS-REFERENCE TO RELATED APPLICATION

This application claims priority to Japanese Patent Application No. 2023-219967 filed on Dec. 26, 2023, incorporated herein by reference in its entirety.

### BACKGROUND

### 1. Technical Field

The present disclosure relates to control devices.

### 2. Description of Related Art

Conventionally, there has been proposed a control device that is used in a motor device including a motor, an inverter that drives the motor, a cooling device (cooler) that cools the inverter with a cooling medium, and a current sensor mounted on a connection line connecting the motor and the inverter. This control device is configured to control the inverter (see, for example, Japanese Unexamined Patent Application Publication No. 2015-136973 (JP 2015-136973 A)). This control device identifies an estimated temperature that is an estimated value of the temperature of the current sensor, based on a cooling medium temperature that is the temperature of the cooling medium, and limits the power output from the motor based on the estimated temperature. The current sensor is thus protected from heat.

### SUMMARY

In recent years, it has been proposed to reduce the area of the connection line of the control device in order to reduce the size of the current sensor. As the area of the connection line is reduced, the current sensor receives more heat from the connection line. Therefore, the estimated temperature may deviate from the actual temperature of the current sensor, and the current sensor may be excessively heated. A possible method to reduce excessive heating of the current sensor is to reduce the threshold of the temperature of the current sensor for determining whether to limit the power output from the motor, or to estimate the temperature of the current sensor to be higher. In this method, however, the power output from the motor is limited frequently, which may reduce the power performance. Therefore, limiting the power output from the motor at a more appropriate timing has been identified as a major task.

A primary object of a control device of the present disclosure is to limit the power output from a motor at a more appropriate timing.

In order to achieve the above primary object, the control device of the present disclosure adopts the following measures.

The control device of the present disclosure is a control device that is used in a motor device including a motor, an inverter that drives the motor, a cooling device that cools the inverter with a cooling medium, and a current sensor mounted on a connection line connecting the motor and the inverter, the control device being configured to control the inverter.

The control device includes an electronic control unit configured to derive an estimated temperature that is an estimated value of a temperature of the current sensor, based on a coil temperature and a cooling medium temperature, and to limit power output from the motor based on the estimated temperature, the coil temperature being a temperature of a coil of the motor, and the cooling medium temperature being a temperature of the cooling medium.

The control device of the present disclosure derives the estimated temperature, namely the estimated value of the temperature of the current sensor, based on the coil temperature and the cooling medium temperature, namely based on the temperature of the coil of the motor and the temperature of the cooling medium. The estimated temperature can thus be made closer to an actual temperature of the current sensor. The power output from the motor is then limited based on the estimated temperature. Since the power output from the motor is limited based on the estimated temperature that is closer to the actual temperature of the current sensor, the power output from the motor can be limited at a more appropriate timing.

In such a control device of the present disclosure, the electronic control unit may be configured to estimate a reached temperature based on the coil temperature and the cooling medium temperature and to perform a first-order lag process on the reached temperature to calculate the estimated temperature. The reached temperature is a temperature that is reached by the current sensor.

The estimated temperature can thus be made closer to the actual temperature of the current sensor. Therefore, the power output from the motor can be limited at a more appropriate timing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram for explaining a configuration of a battery electric vehicle 10 in which a control device of the present embodiment is mounted;

FIG. 2 is an explanatory view for explaining an outline of a configuration around the current sensor 23u; and

FIG. 3 is a flowchart illustrating an example of a control routine executed by the electronic control unit 60.

### DETAILED DESCRIPTION OF EMBODIMENTS

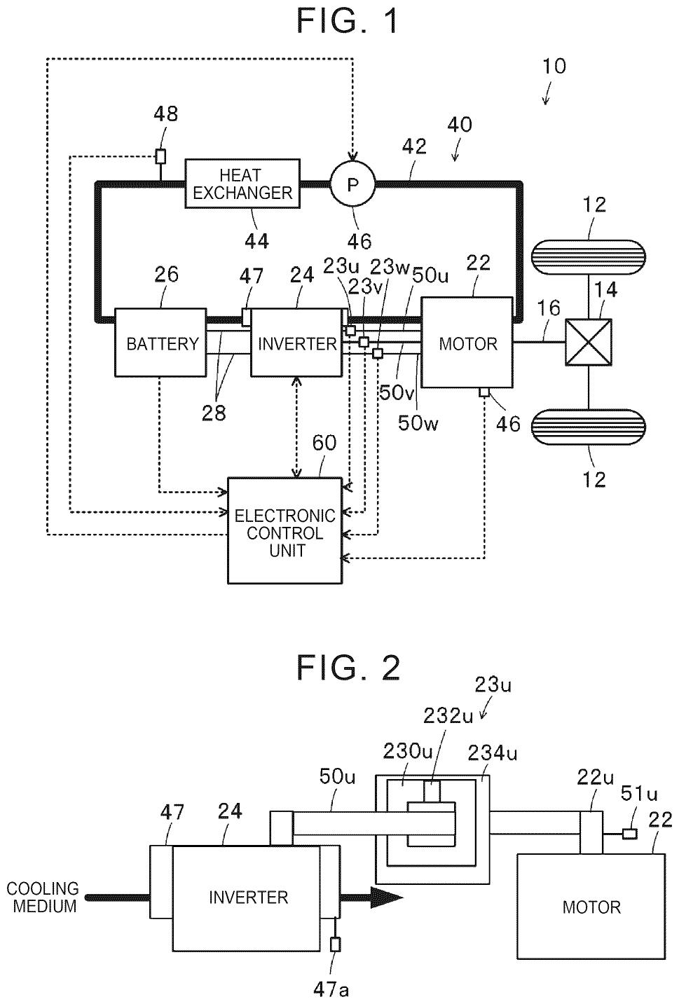

Embodiments of the present disclosure will be described with reference to the drawings. FIG. 1 is a schematic configuration diagram for explaining a configuration of a battery electric vehicle 10 in which a control device of the present embodiment is mounted. FIG. 2 is an explanatory diagram for explaining an outline of a configuration around the current sensor 23u. As illustrated in FIG. 1, battery electric vehicle 10 includes a motor 22, an inverter 24, a battery 26 serving as a power storage device, a cooling device 40, and an electronic control unit 60 serving as a control device. In battery electric vehicle 10, at least the motor 22 and the inverter 24 are housed in the same motor room (vehicle body space).

The motor 22 is configured as a three-phase AC motor, and includes a rotor in which a permanent magnet is embedded in a rotor core, and a stator in which U-phase, V-phase, and W-phase coils are respectively wound around the stator core. The rotor of the motor 22 is connected to a drive shaft 16 which is connected to the drive wheels 12 via a differential gear 14.

Inverter 24 is used to drive motor 22 and is connected to battery 26 via power line 28. The inverter 24 has six transistors as six switching elements and six diodes. The six transistors are arranged in pairs by two each, so as to be on the source side and the sink side with respect to the positive electrode side line and the negative electrode side line of the power line 28, respectively. Each of the connecting points of the six transistor pairs is connected to each of the three-phase (U-phase, V-phase, and W-phase) coils of the motor 22 via a bus bar 50u, 50v, 50w as a connection line. Therefore, when a voltage is applied to the inverter 24, the electronic control unit 60 adjusts the ratio of the on-time of the pair of transistors, thereby forming a rotating magnetic field in the three-phase coil and rotationally driving the motor 22. A current sensor 23u, 23v, 23w is attached to the bus bar 50u, 50v, 50w. As shown in FIG. 2, the current sensor 23u includes a magnetism collection core 230u, a Hall IC 232u installed in the magnetism collection core 230u, and a resin-molded 234u that seals the magnetism collection core 230u and the Hall IC 232u. The current sensor 23u measures a current of the bus bar 50u by measuring a magnetic field generated in the magnetism collection core 230u by a current flowing in the bus bar 50u. Since the current sensor 23v, 23w has the same configuration as that of the current sensor 23u, the explanation thereof will be omitted.

The battery 26 is configured as a secondary battery such as a lithium-ion secondary battery. The battery 26 is connected to the inverter 24 via the power line 28, as described above.

The cooling device 40 includes a circulation flow path 42, a heat exchanger 44, an electric pump 46, and a cooler 47. The cooler 47 is attached to the inverter 24 for exchanging heat with the inverter 24 to cool the inverter 24. The circulation flow path 42 is configured as a flow path for circulating the cooling medium to the motor 22, the cooler 47, the battery 26, and the heat exchanger 44 in this order. The electric pump 46 circulates the cooling medium in the circulation flow path 42. The circulation flow path 42 may be configured such that the cooling medium circulates in the order of the cooler 47, the motor 22, the battery 26, and the heat exchanger 44, or may be configured such that the cooling medium circulates in the order of the battery 26, the motor 22, the cooler 47, and the heat exchanger 44.

The electronic control unit 60 includes a microcomputer, and the microcomputer includes a CPU, a ROM, RAM, a flash memory, an input/output port, and a communication port. The electronic control unit 60 receives signals from various sensors. For example, the electronic control unit 60, the rotational position θm of the rotor of the motor 22 from the rotational position sensor (not shown), U-phase, V-phase, W-phase currents Iu, Iv, Iw of the motor 22 from the current sensor 23u, 23v, 23w, the bus bar 50u, 50v, 50w and the motor 22 motor bus bar 22u, 22v, 22w connected to the three-phase coil (only the motor bus bar 22u is shown in FIG. 2) to detect the temperature of the temperature sensor 51u, 51v, 51w (only the temperature sensor 51u is shown in FIG. 2) coil temperature αcu, αcv, αcw, the cooling medium temperature αw as a temperature sensor 47a for detecting the temperature of the cooling medium passing through the cooler 47 is inputted.

The electronic control unit 60 outputs various control signals. For example, the electronic control unit 60 outputs a control signal to the inverter 24 and a control signal to the electric pump 46. The electronic control unit 60 calculates the electric angle θe and the rotational speed Nm of the motor 22 based on the rotational position θm of the rotor of the motor 22. The electronic control unit 60 calculates the power storage ratio SOC of the battery 26 based on the integrated value of the current Ib of the battery 26.

In battery electric vehicle 10 of the embodiment configured as described above, the electronic control unit 60 sets the required torque Td* required for the drive shaft 16 based on the accelerator operation amount Acc and the vehicle speed V as the opening degree of the accelerator pedal, sets the torque command Tm* of the motor 22 so that the set required torque Td* is outputted to the drive shaft 16, and performs switching control of the transistors of the inverter 24 so that the motor 22 is driven by the torque command Tm*. Hereinafter, the control of the motor 22 (inverter 24) is referred to as “normal control”.

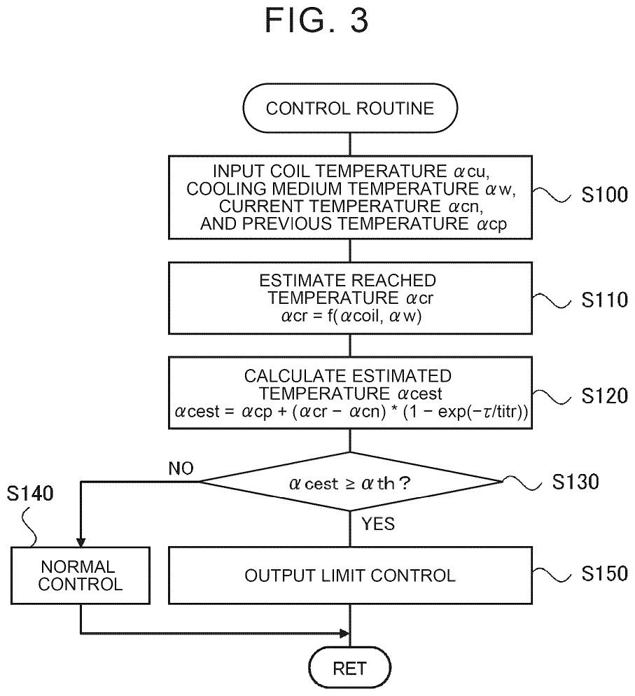

Next, the operation of battery electric vehicle 10 of the embodiment configured in this way, in particular, the operation when suppressing the excessive temperature rise of the current sensor 23u will be described. FIG. 3 is a flowchart illustrating an example of a control routine executed by the electronic control unit 60. This routine is repeatedly executed every titr (for example, several msec) for a predetermined period from the time when battery electric vehicle 10 is started up to the time when the system is stopped. The temperature or the like entered or set by the control routine is reset to a value 0 or a predetermined value when battery electric vehicle 10 is shut down. Note that, in the embodiment, the operation when the excessive temperature rise of the current sensor 23u is suppressed is described, but the excessive temperature rise of the current sensor 23v, 23w can be suppressed by the same operation.

When this routine is executed, CPU of the electronic control unit 60 executes a process of inputting the coil temperature αcu, the cooling medium temperature αw, the present temperature αcn, and the previous temperature αcp (S100). The coil temperature αcu is inputted as the coil temperature detected by the temperature sensor 51u. The cooling medium temperature αw is inputted as detected by the temperature sensor 47a. The current temperature αcn is an estimated temperature αcest after a lapse of a predetermined period of titr calculated by a S120 to be described later when the previous routine is executed, that is, an estimated value of the current temperature of the current sensor 23u. The previous temperature αcp is an estimated temperature αcest after a lapse of a predetermined period of titr calculated by a S120 described later when the present routine is executed last time, that is, an estimated value of the previous temperature of the current sensor 23u. When battery electric vehicle 10 is started up and the routine is executed for the first time, the present temperature αcn and the previous temperature αcp are not set. In this case, the reached temperature αcr set by S110 described later may be used as the present temperature αcn and the previous temperature αcp.

Next, based on the coil temperature αcu and the cooling medium temperature αw, the reached temperature αcr as the temperature of the current sensor 23u when there is no delay in the change in the temperature of the current sensor 23u with respect to the change in the temperature of the cooling medium after passing through the cooler 47 and the change in the temperature of the coil of the motor 22 is estimated (S110). The reached temperature αcr is estimated to be higher when the coil temperature αcu is high than when the coil temperature αcu is low and higher when the cooling medium temperature αw is high than when the coil temperature αcu is low. The reason why the reached temperature αcr is higher when the coil temperature αcu is higher than when the coil temperature αcu is higher is based on the fact that the current sensor 23u is easily heated by receiving heat from the coil of the motor 22 via the bus bar 50u when the coil temperature αcu is higher. Further, the reason why the reached temperature αcr is higher than when the cooling medium temperature αw is higher than when the cooling medium temperature αw is lower is based on the fact that the cooling performance of the cooling device 40 is lowered when the cooling medium temperature αw is higher, and the current sensor 23u is easily heated.

Then, the reached temperature αcr is subjected to the first-order lag process using the following equation (1), and the estimated temperature αcest as an estimated value of the temperature after the predetermined time titr of the current sensor 23u is calculated (S120). In the following equation (1), “T” is a value determined in advance by experimentation, analysis, machine learning, or the like as a time constant of a change in temperature of the current sensor 23u with respect to a change in temperature of the cooling medium after passing through the cooler 47 and a change in temperature of the coil of the motor 22. The change in temperature of the current sensor 23u changes with a certain delay with respect to the change in temperature of the coil of the motor 22 and the change in temperature of the cooling medium after passing through the cooler 47. Therefore, the estimated temperature αcest can be made closer to the actual temperature of the current sensor 23u after titr of the predetermined time by performing the first-order lag process on the reached temperature αcr and calculating the estimated temperature αcest as the estimated value of the temperature after titr of the predetermined time of the current sensor 23u.

$$α cest = α cp + ( α cr - α cn ) * ( 1 - exp ( - τ / titr ) ) \qquad ( 1 )$$

Next, it is determined whether the estimated temperature αcest is equal to or greater than the threshold αth (S130). The threshold value αth is a value determined in advance by experimentation, analysis, machine-learning, or the like as a threshold value of the temperature of the current sensor 23u that can determine that the temperature of the current sensor 23u should limit the output from the motor 22. Therefore, S130 is a process of determining whether the power from the motor 22 should be limited.

When the estimated temperature αcest is less than the threshold value αth in S130, the above-described normal control is executed (S140), and this routine is ended. When the estimated temperature αcest is equal to or higher than the threshold αth in S130, an output limit control for limiting the output from the motor 22 is executed (S150). Exit this routine. In the output limit control, the required torque Td* required for the drive shaft 16 based on the accelerator operation amount Acc and the vehicle speed V as the opening degree of the accelerator pedal is set to be smaller than the required torque Td* set at the same accelerator operation amount Acc and the vehicle speed V in the above-described normal control, the torque command Tm* of the motor 22 is set so that the set required torque Td* is output to the drive shaft 16, and the switching control of the transistors of the inverter 24 is performed so that the motor 22 is driven at the torque command Tm*. By executing the power limit control, the temperature rise of the motor 22 is suppressed, and the amount of heat received by the bus bar 50u is reduced, so that the temperature rise of the current sensor 23u can be suppressed and the current sensor 23u can be protected. Further, since the output limit control is executed on the basis of the estimated temperature αcest which is closer to the actual temperature of the current sensor 23u, the power output from the motor 22 can be limited at a more appropriate timing.

According to battery electric vehicle 10 in which the control device of the present embodiment described above is mounted, the estimated temperature αcest as an estimated value of the temperature of the current sensor 23u is derived based on the coil temperature αcu as the temperature of the coil of the motor 22 and the cooling medium temperature αw as the temperature of the cooling medium, and the power output from the motor 22 is limited based on the estimated temperature αcest, so that the power output from the motor 22 can be limited at a more appropriate timing.

Further, since the reached temperature αcr as the temperature reached by the current sensor 23u is estimated based on the coil temperature αcu and the cooling medium temperature αw, and the estimated temperature αcest is calculated by performing the first-order lag process on the reached temperature αcr, the power outputted from the motor 22 can be limited at a more appropriate timing.

In the above embodiment, the estimated temperature αcest obtained by performing the first-order lag process on the reached temperature αcr is calculated, and the output limit control is executed when the estimated temperature αcest is equal to or higher than the threshold value αth. However, when the temperature change of the current sensor 23u can follow the temperature change of the cooling medium after the temperature change of the coil of the motor 22 and the temperature change of the cooling medium after passing through the cooler 47 sufficiently quickly, the reached temperature αcr may be set to the estimated temperature αcest, and when the estimated temperature αcest is equal to or higher than the threshold αth, the power limit control may be executed.

In the above-described embodiment, in the output limit control, the power output from the motor 22 is limited by setting the required torque Td* to be smaller than the above-described normal control. However, the motor 22 may be driven by torque in which the torque command Tm* is set in the same manner as the normal control, and the torque command Tm* is limited by the upper limit torque Tmax. The upper limit torque Tmax may be a value determined in advance by experimentation, analysis, machine learning, or the like as an upper limit value of the outputting torque of the motor 22 in which the current sensor 23u excessively increases in temperature.

In the above-described embodiments, the control device of the present disclosure is applied to a battery electric vehicle 10. However, the control device of the present disclosure may be applied to a hybrid electric vehicle that can be driven by power from an engine and power from a motor. Further, the control device of the present disclosure is not limited to the device applied to the automobile, and can be applied to any type of motor device including the motor 22, the inverter 24, the cooling device 40, and the current sensor 23u.

The correspondence between the main elements of the embodiments and the main elements of the disclosure described in the column of the means for solving the problem will be described. In the embodiment, the motor 22 corresponds to the “motor”, the inverter 24 corresponds to the “inverter”, the cooling device 40 corresponds to the “cooling device”, the current sensor 23u corresponds to the “current sensor”, and the electronic control unit 60 corresponds to the “control device”.

Note that the correspondence between the main elements of the embodiment and the main elements of the disclosure described in the section of the means for solving the problem is an example for specifically explaining the embodiment of the disclosure described in the section of the means for solving the problem, and therefore the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Although the embodiments for carrying out the present disclosure have been described above, the present disclosure is not limited to such embodiments at all, and it is needless to say that the present disclosure can be carried out in various forms without departing from the gist of the present disclosure.

The present disclosure is applicable to a manufacturing industry of a control device and the like.

What is claimed is:

1. A control device that is used in a motor device including a motor, an inverter that drives the motor, a cooling device that cools the inverter with a cooling medium, and a current sensor mounted on a connection line connecting the motor and the inverter, the control device being configured to control the inverter, and comprising an electronic control unit configured to derive an estimated temperature that is an estimated value of a temperature of the current sensor, based on a coil temperature and a cooling medium temperature, and to limit power output from the motor based on the estimated temperature, the coil temperature being a temperature of a coil of the motor, and the cooling medium temperature being a temperature of the cooling medium.

2. The control device according to claim 1, wherein the electronic control unit is configured to estimate a reached temperature based on the coil temperature and the cooling medium temperature and to perform a first-order lag process on the reached temperature to calculate the estimated temperature, the reached temperature being a temperature that is reached by the current sensor.
